(19) United States
(12) Patent Application Publication
(10) Pub. No.: US 2002/0000700 A1
(43) Pub. Date: Jan. 3, 2002

(54) Disposable shopping cart sheath

(76) Inventors: Andre Alexsen, Sherman Oaks, CA (US); Tony J. Mireles, North Hollywood, CA (US); John J. Marshall, Studio City, CA (US)

Correspondence Address: STETINA BRUNDA GARRED & BRUCKER, 75 ENTERPRISE, SUITE 250, ALISO VIEJO, CA, 92656, US

(21) Appl. No.: 09/925,857

(22) Filed: Aug. 9, 2001

Related U.S. Application Data
(63) Continuation of application No. 09/281,558, filed on Mar. 30, 1999.

(51) Int. Cl. B62D 39/00

(52) U.S. Cl. 280/33.992

(57) ABSTRACT

A disposable shopping cart sheath and method of using the same. The sheath comprises a sheet of plastic material, such as polyethylene, which is manually wrapped radially about the handle of a conventional shopping cart. According to a first preferred embodiment, the sheath is formed to have a generally triangular shape with an elongate slit formed in generally parallel relation along a respective side thereof, and opposite a respective corner or point of the triangular member. Such corner or point of the triangular member is insertable through the slit to thus enable the sheath to radially wrap about the handle member. In a second alternative embodiment, the sheath comprises a generally rectangular sheet of plastic material that is designed to cling to the handle as well as itself to thus stay wrapped about the handle during use. Following use, the sheaths are simply disposed of and may be recycled.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

As is well-known, the primary route by which communicable diseases are transmitted is person-to-person contact and contact via airborne droplet spray contaminants having pathogens, namely bacteria and viruses, that can transmit infection. Influenza A and pneumonia are but two of numerous debilitating conditions that are caused by pathogens that are easily and readily transferable between individuals. Also falling within this same group of communicable diseases include food poisoning, and in particular food poisoning caused by Escherichia coli, normally found in undercooked and/or ground red meat, salmonella, which is typically found in chicken meat products, and hepatitis A virus, responsible for producing hepatitis A, may be found in contaminated raw shellfish.

Further compounding the problems posed by the ease of transmissibility of such pathogens, as well as the debilitating diseases caused thereby, is the practice by which most Americans, if not most of Western society, purchase food products. In this regard, a majority of Americans purchase food and other household items at large grocery stores and utilize shopping carts to temporarily hold the groceries sought to be purchased as the purchaser advances through the store.

Such shopping carts, which are well-known in the art, generally comprise a metal or wire frame defining a generally block-shaped basket member which is supported by four wheels. A handle member is further provided to enable the user to push the shopping cart throughout the store. There is further optionally provided a seat for a small child, which typically orients the child seated therein to face the individual pushing the cart when in use. In fact, large, well-recognized chain stores are dependent upon shopping carts to enable their customers to effectively shop therein. Among the more well-known stores include Wal-Mart, K-Mart and Home Depot, not to mention well-known grocery store chains including Safeway, Vons, Kroger and Meijer.

The use of shopping carts, however, can be problematic. Generally, such shopping carts are repeatedly utilized by a succession of customers on a daily basis and typically no action is taken to clean or otherwise insure the cleanliness of shopping carts. As such, there is thus created tremendous potential for communicable diseases to be transmitted thereby. In particular, the handle member of a given shopping cart may be handled by dozens of people in a given day and, as a consequence, can serve to actually facilitate the spread of infectious pathogens. The handle member of the shopping cart is further frequently exposed to infectious pathogens to the extent a child seated within the shopping cart, who is typically in close proximity to the shopping cart handle, can drool, touch, and/or sneeze upon the handle, and thus has the ability to further saturate the handle with such infectious pathogens.

To date, however, there is no method by which shopping carts, and more particularly the handle portion thereof, are treated on a regular basis to reduce such transmissibility of disease, much less cleaned or made sterile when a given shopping cart is transferred from one customer to another. In this regard, it is impractical to thoroughly clean a given shopping cart, and in particular the handle portion thereof, following use by a given customer. Disposable or single-use shopping carts and/or shopping cart handles are impractical insofar as the same are cost and labor prohibitive.

Accordingly, there is a need in the art for an inexpensive system and procedure by which a shopping cart, and more particularly the handle portion thereof, can be protected from serving as a transmissible source of communicable disease-causing pathogens. There is a further need in the art for a simple system and procedure that substantially reduces the probability by which an individual can become infected with a disease-causing pathogen by virtue of handling a conventional shopping cart. There is still further a need in the art for such system and procedure that is simple to use, can be easily and readily deployed, and may be utilized with virtually all types of conventional shopping carts currently in use.

### BRIEF SUMMARY OF THE INVENTION

The present invention specifically addresses and alleviates the above-identified deficiencies in the art. In this regard, the present invention is directed to a disposable shopping cart sheath that is wrapped about the handle portion of a conventional shopping cart and removed therefrom prior to and after use of the shopping cart. The sheath is preferably comprised of a thin sheet of plastic material, such as polyethylene, cellophane, or any of a variety of plastic materials well-known to those skilled in the art, that acts to form a physical barrier between the shopping cart handle and the individual's hands that are placed upon the handle to push and direct the shopping cart. According to a first preferred embodiment, the sheath is formed to have a generally triangular shape having an elongate slit formed in generally parallel relation along a respective side thereof and formed opposed from a respective point or corner of said generally triangular sheet. In use, the sheath is wrapped radially about the handle portion of a shopping cart with the opposed point of the triangular sheet being slid into and pulled through the slit formed upon the sheath until a tight wrapping is formed about the handle. The shopping cart may then be utilized as per conventional shopping carts with the user placing his or her hands about the sheath to direct the shopping cart via the handle. Following use of the cart, the sheath is manually pulled from the handle, and may be either torn off or simply pulled therefrom. In a further refinement of the present invention, the sheath may be provided with one or more perforated segments to facilitate removal of the sheath from the shopping cart handle.

According to a second preferred embodiment, the sheath comprises a generally rectangular sheet of plastic wrap, which may comprise polyethylene or any other suitable type polymer, that is manually wrapped radially about the handle member of the shopping cart. The plastic preferably possesses self-cling properties such that when radially wrapped about the handle portion of the shopping cart, the sheath is caused to tightly cling thereabout as well as adhere to itself. As per the first embodiment, once sufficiently wrapped about the handle member, the shopping cart may be utilized as it would be ordinarily. Similarly, following use of the cart, the sheath may be manually pulled or torn from the handle and disposed.

In either the first or second embodiments, it is contemplated that the disposable sheaths of the present invention may be supplied in rolls and placed in close proximity to the area where the shopping carts of a given store are located so that each individual user can simply access a given sheath and manually wrap the same about the handle portion of a given shopping cart by his or herself. Likewise, such sheaths may be formed to be recyclable.

It is therefore an object of the present invention to provide a disposable shopping cart sheath which effectively and efficiently decreases the transmissibility of pathogens present upon the handle of the shopping cart to an individual utilizing the same.

Another object of the present invention is to provide a disposable shopping cart sheath that, in addition to providing a sanitary barrier between the handle of a shopping cart and individual using the same, is further of simple construction, easy to utilize, and inexpensive to manufacture.

A still further object of the present invention is to provide a disposable shopping cart sheath that can be utilized or adapted to be utilized with virtually all types of shopping carts currently in use and/or later developed.

### BRIEF DESCRIPTION OF THE SEVERAL VIEWS OF THE DRAWING

These, as well as other features of the present invention will become more apparent upon reference to the drawings wherein:

FIG. 1 is a perspective view of a conventional shopping cart having a handle portion formed thereon, that further depicts a disposable shopping cart sheath constructed in accordance to a first preferred embodiment of the present invention.

FIG. 2 is a frontal view of the disposable shopping cart sheath shown in FIG. 1.

FIG. 3 is a perspective view of the shopping cart sheath of FIG. 1 being deployed radially about the shopping cart handle of FIG. 1.

FIG. 4 is a perspective view of a disposable shopping cart sheath constructed in accordance with a second preferred embodiment of the present invention.

FIG. 5 is a perspective view of the shopping cart sheath of FIG. 4 being deployed radially about the shopping cart handle of FIG. 1.

### DETAILED DESCRIPTION OF THE INVENTION

The detailed description as set forth below in connection with the appended drawings is intended as a description of the presently preferred embodiments of the invention, and is not intended to represent the only form in which the present invention may be constructed or utilized. The description sets forth the functions and sequences of steps for constructing and operating the invention in connection with the illustrated embodiments. It is understood, however, that the same or equivalent functions and sequences may be accomplished by different embodiments and that they are also intended to be encompassed within the scope of this invention.

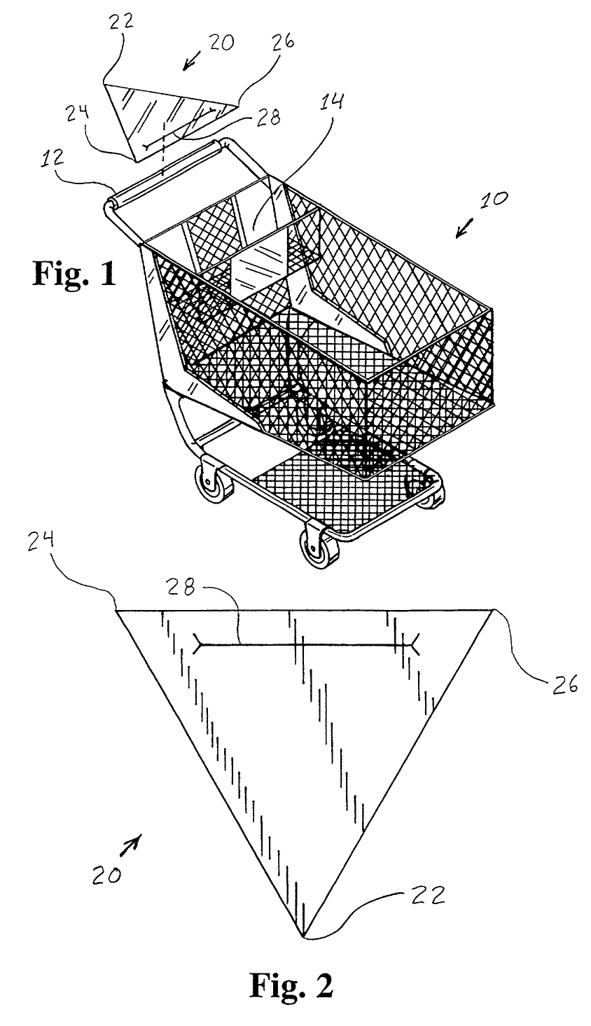

Referring now to the drawings, and initially to FIG. 1, there is shown a conventional shopping cart 10 having a handle portion 12 formed thereon along with a disposable shopping cart sheath 20 constructed according to a first preferred embodiment of the present invention. As is well-known, such shopping carts 10 are utilized extensively throughout the United States and the rest of the world as a convenient means for holding a variety of consumer items, most notable of which being groceries, during the time the consumer shops throughout a given store. Among the more well-known chain stores utilizing such shopping carts include Wal-Mart, K-Mart and Home Depot, as well as virtually every chain of grocery stores in the United States and Canada.

Given the fact that such handle portion 12 is manually held by multiple individuals during a given shopping day, coupled with the fact that such shopping carts typically provide a seat 14 for a small child who is placed in close proximity to the handle portion 12, and thus may also touch, drool and/or sneeze upon such handle member 12, it is known that such handles are a major vector for propagating communicable diseases. In this regard, it is known that a wide variety of infectious pathogens are easily and readily transmissible from one individual to another via the handle 12 of shopping carts 10. Such shopping cart handles 12 are further known to facilitate the communicability of pathogens responsible for causing food poisoning, including E-coli, salmonella, and even the hepatitis A virus. To date, however, there is no effective way of preventing or otherwise substantially minimizing how such infectious pathogens may be transmitted from the shopping cart handle 12 to the hands of a user thereof.

To address such long-felt need in the art, there is provided herein a disposable shopping cart sheath that eliminates or substantially minimizes the ability by which infectious pathogens may be transmitted from the handle of a shopping cart to the hands of the user of the shopping cart. Referring to FIGS. 1 and 2, there is shown the first embodiment 20 of the disposable sheaths of the present invention. As illustrated, the sheath 20 is formed to have a generally triangular shape defining three points or corners 22, 24, 26. Formed in generally parallel relation with a respective side of such sheath is an elongate slit 20, the latter being formed generally opposed point or corner 22. The sheath 20 is preferably formed from a thin sheet of plastic material, such as polyethylene, polypropylene, cellophane, or any of a variety of plastic materials well-known to those skilled in the art that may be sterilized and kept in sterilized condition.

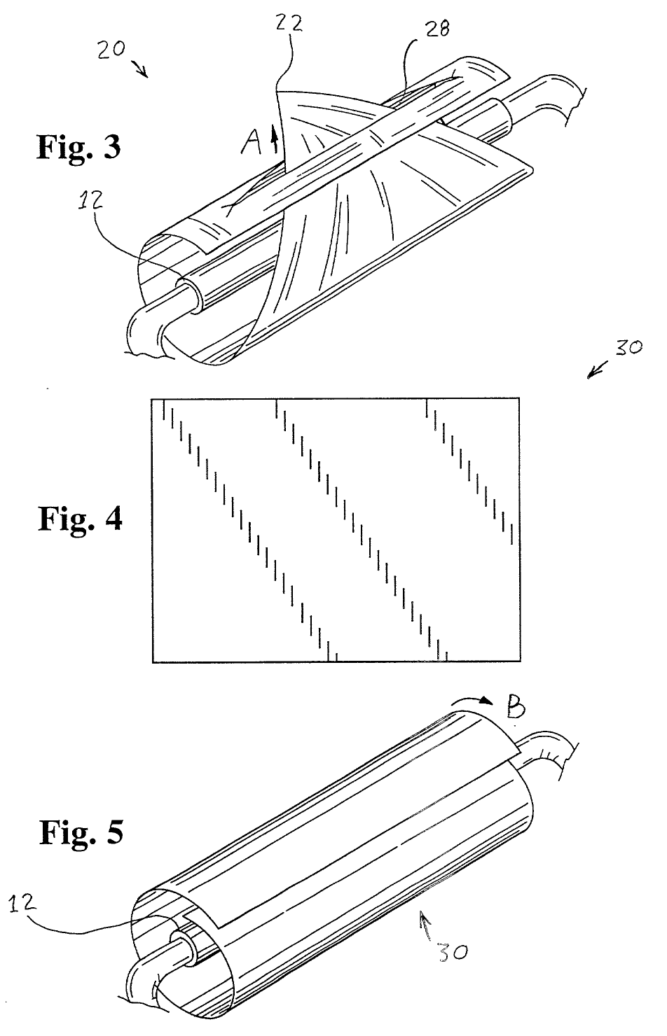

Referring now to FIG. 3, the sheath according to the first embodiment 20 depicted in FIG. 2 is shown being radially wrapped about the handle portion 12 of the shopping cart 10. As illustrated, the sheath 20 is first radially wrapped about the handle 12 with corner or point 22 formed across the elongate slit 28 is caused to curve upwardly in the direction indicated by the letter A and is slid therethrough. Once sufficiently advanced into the slit 28, the corner or point 22 may be manually pulled upwardly or downwardly as is warranted to enable the sheath to radially compress about the length of the handle 12. Currently, most handle members are formed to have a length of approximately 19 inches and have a radius of approximately 3½ inches. Accordingly, to accommodate such conventional lengths, it is contemplated that the disposable sheath of the present invention, according to the first embodiment, should be formed as a regular triangle wherein each side is formed to have a length of approximately 19 inches. The slit 28 formed thereupon should be formed to have a length of approximately 7 inches, and should preferably be formed approximately 4 inches away from the side or peripheral edge running in generally parallel relation therealong. In this regard, it will be understood that the slit 28 must be formed a sufficient distance from the side or peripheral edge of the triangle such that when corner edge 22 is pulled therethrough, the sheath 20 will retain enough structural strength to remain tightly wrapped around the handle member 12 without breaking, tearing or otherwise becoming substantially deformed.

Once so wrapped about the handle portion 12, the shopping cart 10 may be utilized as per conventional shopping carts. In this regard, the user may manually grasp the handle 12 with the sheath wrapped thereabout and push and direct it as normal. Advantageously, the sheath of the present invention provides a physical barrier impenetrable to infectious pathogens, namely bacteria and viruses, that would otherwise come directly into contact with the user's hands. Following the shopping experience, the user need only rip the sheath away from the handle member and dispose the sheath. To facilitate such removal, it is contemplated that the sheath may be provided with one or more perforations to facilitate tearing such sheath away from the handle portion.

Referring now to FIGS. 4 and 5, and initially to FIG. 4, there is shown a disposable shopping cart sheath constructed in accordance to a second preferred embodiment 30 of the present invention. As depicted, the sheath 30 comprises a flat, generally rectangular sheet of plastic material, which preferably comprises polyurethane, polypropylene, cellophane or any other plastic polymer material well-known to those skilled in the art. As per the first embodiment, the sheath 30 is wrapped about the handle portion 12 of a conventional shopping cart such that the same becomes radially wrapped thereabout, by rotating the sheath 30 in the direction indicated by the letter B, as depicted in Figure B. Preferably, the plastic from which the sheath 30 is formed will have self-cling properties similar to conventional cling-wrap plastics to thus enable the same to adhere not only to the handle portion 12, but also cling to itself as the same is radially wrapped about the handle.

To accommodate most conventional shopping cart handles currently in use, which as discussed above typically have lengths of approximately 19 inches, and diameters of approximately 3½ inches, the sheath should be formed to have a length of approximately 19 inches and a width of approximately 5 inches. It will be understood, however, that such sheets can be adjusted in size and shape and still accomplish their intended purpose of providing a physical barrier between the handle portion of the shopping cart and the hands of the individual pushing and directing the same.

Once sufficiently wrapped radially about the handle member 12 of the shopping cart 10, the cart 10 may be utilized as it ordinarily would. Once the individual utilizing such cart has completed his or her shopping, such individual need only remove the sheath 30 from the handle 12 and dispose of the same. In this regard, it is contemplated that one or more perforations may be formed about the sheath to enable the same to be easily and readily torn from the handle portion of the shopping cart. Advantageously, because of the plastic nature of the sheaths of the present invention, it is contemplated that such sheaths can be recycled as per conventional recycling practices.

In addition to the foregoing, it is contemplated that in either of the aforementioned embodiments, the disposable sheaths of the present invention may be formed and packaged as rolls or folded over in sheets to thus enable the same to be easily and readily accessed by individuals at a given store. In this respect, it is contemplated that each respective individual wishing to utilize a cart may simply pull off or remove a respective one of a plurality of sheaths and utilize the same as discussed above. Along these lines, it is contemplated that such disposable sheaths may be provided similar to produce bags provided in the produce sections of most grocery stores, typically in rolls, that can be individually pulled therefrom and utilized to hold fruits, vegetables, and the like.

Although the invention has been described herein with specific reference to a presently preferred embodiment thereof, it will be appreciated by those skilled in the art that various modifications, deletions, and alterations may be made to such preferred embodiment without departing from the spirit and scope of the invention. For example, it is contemplated that the disposable sheaths of the present invention may take any of a variety of sizes and shapes other than the triangular and rectangular embodiments discussed herein. In addition, it will be recognized that the disposable sheaths of the present invention need not be limited to use with shopping carts, but can be utilized in a wide variety of applications. For example, the sheaths of the present invention may be utilized in handling luggage insofar as the sheaths of the present invention may be utilized to form a protective barrier between the handle portion of such luggage and an individuals hands. Moreover, it is contemplated that the sheaths of the present invention may be utilized in combination with smaller hand-held shopping baskets, which are typically made available to shoppers who only need them to carry a few items and do not require larger shopping carts. In this respect, the scope and spirit of the present invention should not be limited to such geometric shapes, as well as how the same are affixed radially about the handle portion of a given shopping cart. Accordingly, it is intended that all reasonably foreseeable additions, modifications, deletions and alterations be included within the scope of the invention as defined in the following claims.

What is claimed is:

1. A sheath for reducing the transmissibility of pathogens from the handle portion of a shopping cart to the hands of an individual using the same comprising a flat sheet of plastic material wrappable about said handle portion, said sheet of plastic material being sized and configured to substantially cover said handle portion such that said sheet of plastic material forms a physical barrier between the user's hands and the handle portion of said cart.

2. The sheath of claim 1 wherein said sheath is formed to have a generally triangular shape having an elongate slit formed in generally parallel relation along a respective side of said generally triangular sheet, said slit being designed and configured to receive a respective corner of said triangle therethrough to enable said sheet to be radially wrapped about said handle portion of said shopping cart.

3. The sheath of claim 2 wherein said sheet is formed to have the shape of a regular triangle.

4. The sheath of claim 1 wherein said sheath is disposable.

5. The sheath of claim 2 wherein said sheath is disposable.

6. The sheath of claim 1 wherein said sheath is formed to have a generally rectangular shape, said sheath being formed from a plastic having sufficient cling properties such that when radially wrapped about said handle portion of said shopping cart, said sheet of plastic material remains radially affixed thereto.

7. The sheath of claim 6 wherein said generally rectangular sheath is formed to have a length of approximately 19 inches and a width of approximately 4 inches.

8. The sheath of claim 6 wherein said generally rectangular sheet is formed from a plastic selected from the group consisting of polyethylene, polypropylene and cellophane.

9. The sheath of claim 2 wherein said sheath is formed from a plastic selected from the group consisting of polyethylene, polypropylene and cellophane.

10. The sheath of claim 6 wherein said sheath is disposable.

11. The sheath of claim 2 wherein said sheath further includes a plurality of perforations formed thereon such that following use, said sheath can be readily torn from said handle portion of said shopping cart.

12. The sheath of claim 6 wherein said sheath further includes a plurality of perforations formed thereon such that following use of said shopping cart, said sheath can be readily torn from said handle portion of said shopping cart.

13. A system for preventing the transmissibility of pathogens from the handle portion of a shopping cart to the hands of an individual using the same comprising a multiplicity of flat sheets of plastic wrappable about said handle portion, each one of said multiplicity of sheets being sized and configured to substantially cover said handle portion such that said sheets of plastic material form a physical barrier between the user's hands and the handle portion of said cart, said multiplicity of sheets of plastic material being formed as a roll such that each respective one of said multiplicity of sheets may be selectively and individually removed therefrom.

14. The system of claim 13 wherein each respective one of said multiplicity of sheaths is formed to have a generally rectangular shape and further having an elongate slit formed in generally parallel relation along a respective side of said generally triangular sheet, said slit being designed and configured to receive a respective corner of said triangle therethrough to enable said sheet to be radially wrapped about said handle portion of said shopping cart.

15. The system of claim 13 wherein each respective one of said multiplicity of sheaths is formed to have a generally rectangular shape, said sheath being formed from a plastic having sufficient cling properties such that when radially wrapped about said handle portion of said shopping cart, said sheet of plastic material remains radially affixed thereto.

16. The system of claim 13 wherein each respective one of said multiplicity of sheaths are disposable.

17. The sheath of claim 1 wherein said plastic is formed from a recyclable material.

18. The system of claim 13 wherein each respective one of said multiplicity of sheaths is formed from a recyclable material.

19. A method for reducing the transmissibility of pathogens from the handle portion of a shopping cart to the hands of an individual using the same comprising the steps:
a) providing a sheet of plastic material, said sheet of plastic material being sized and configured to substantially cover said handle portion of said shopping cart; and
b) wrapping said sheet of plastic material radially about said handle portion such that said sheet of plastic material forms a physical barrier between the user's hands and the handle portion of said cart.

20. The method of claim 19 wherein said sheet is formed to have a generally triangular shape.

21. The method of claim 20 wherein said sheet is formed to have a generally rectangular shape.
